(19) United States
(12) Patent Application Publication
(10) Pub. No.: US 2024/0375750 A1
(43) Pub. Date: Nov. 14, 2024

(54) DRIVE DEVICE FOR AN ELECTRIC BICYCLE AND ELECTRIC BICYCLE

(71) Applicant: Porsche eBike Performance GmbH, Ottobrunn (DE)

(72) Inventors: Johannes Biechele, Ottobrunn (DE); Julius Thorwart, Ottobrunn (DE)

(21) Appl. No.: 18/557,511

(22) PCT Filed: Feb. 24, 2022
(86) PCT No.: PCT/EP2022/054674

§ 371 Date: Oct. 26, 2023

(30) Foreign Application Priority Data
Apr. 27, 2021 (DE) 10 2021 110 719.9

(51) Int. Cl. B62M 6/55; B62M 6/50; B62M 11/14

(52) U.S. Cl. CPC B62M 6/55; B62M 6/50; B62M 11/145

(57) ABSTRACT

In an embodiment a drive device includes a motor unit having an electric motor configured to drive an electric bicycle, a pedal crankshaft rotatable about an axis of rotation, a gearbox coupled, on the one hand, to the motor unit and, on the other hand, to the pedal crankshaft, the gearbox configured to output a torque for driving the electric bicycle, a motor housing in which the motor unit and the gearbox are arranged and through which the pedal crankshaft extends and a speed sensor unit including a speed sensor and a speed disc, wherein the speed disc is coupled to the pedal crankshaft so as to be rotatable about the axis of rotation, and is arranged outside the motor housing.

### CROSS-REFERENCE TO RELATED APPLICATIONS

This patent application is a national phase filing under section 371 of PCT/EP2022/054674, filed Feb. 24, 2022, which claims the priority of German patent application 102021110719.9, filed Apr. 27, 2021, each of which is incorporated herein by reference in its entirety.

### TECHNICAL FIELD

The invention relates to a drive device for an electric bicycle and an electric bicycle having such a drive device.

### BACKGROUND

Bicycles realize low-cost, easy-to-use and emission-free means of transportation. They have also become widespread as sports or fitness equipment, and types particularly suitable for various sports applications have emerged.

In recent years, there has been growing enthusiasm for electric bicycles (especially so-called “pedelecs”), despite their high weight and price for bicycles. Potential customers are not only older cyclists who are less fit or free of sporting ambitions, but also sporty, younger riders, whether for use on the way to work or because of the possibility of using them to extend the radius of action and/or increase the speed of travel without overstraining one's own physique. Among mountain bikers in particular, interest in electrically assisted mountain bikes seems to be growing. In the case of electric bicycles, it is a challenge to provide a reliably assisting drive system that allows high power transfer.

### SUMMARY

Embodiments provide a reliable drive system for electric bicycles, which allows a particularly clear and space-saving structure.

According to one embodiment, a drive device for an electric bicycle is disclosed. The drive device comprises a motor unit having an electric motor for driving the electric bicycle. The drive device further comprises a pedal crankshaft rotatable about an axis of rotation. The drive device further comprises a gearbox configured to drive the electric bicycle and coupled to the motor unit on the one hand and to the pedal crankshaft on the other hand, and configured to output a torque for driving the electric bicycle. The drive device further comprises a motor housing in which the motor unit and the gearbox are arranged and through which the pedal crankshaft extends. Furthermore, the drive device comprises a speed sensor unit comprising a speed sensor and a speed disc, wherein the speed disc is rotatably coupled to the pedal crankshaft about the axis of rotation and is arranged outside the motor housing.

By means of the described drive device, a reliable drive concept for electric bicycles can be realized, which enables a particularly and space-saving structure. In particular, due to the external arrangement of the speed sensor unit or at least the speed disc, a compact structure of the drive device can be realized, which enables a slim frame design for electric bicycles. The described drive device is particularly suitable as an electric bicycle drive system for mounting on a down tube or on a seat tube of the electric bicycle.

According to a preferred embodiment of the drive device, the speed disc has a spiral-shaped or a helical contour with respect to the axis of rotation, and the speed sensor is arranged in dependence on the contour of the speed disc such that radial or axial speed detection is set up with respect to the axis of rotation.

The rotational speed sensor unit has, for example, a rotational speed sensor in the form of a Hall sensor, which enables a high, virtually stepless sampling rate based on the Hall effect and magnetic fields to be measured. Alternatively or additionally, the speed sensor unit can be designed in such a way that another tachometer method can be implemented, for example by means of a magnetized speed disc.

The speed sensor can also be arranged outside the motor housing or be located inside the motor housing and positioned in such a way that it enables reliable measurement in cooperation with the speed disc located outside. By positioning the speed disc and, if applicable, the speed sensor outside the motor housing, simplified accessibility is provided and beneficial serviceability of the speed disc or speed sensor can be established.

Alternatively, the speed sensor can, for example, be arranged in an existing free space in the motor housing and detect a rotation of the externally mounted speed disc. The motor housing can then have an opening in the direction of the speed disc, for example, through which the speed sensor can detect a rotation of the speed disc and thus enable particularly reliable speed measurement.

According to a further embodiment, the drive device has a cover which covers the speed disc and is coupled to the motor housing so that the speed disc is arranged between the cover and the motor housing. Thus, the speed disc can be reliably and safely arranged outside the motor housing and secured against undesirable external influences. The speed disc is then connected to the externally located end portion of the first part element of the pedal crankshaft, for example, and is rotatably supported between the pedal crankshaft and the motor housing with respect to a state mounted on the electric bicycle.

According to an embodiment of the drive device, the gearbox is formed as a planetary gear having a sun gear and at least one planetary gear and is arranged coaxially around the pedal crankshaft with respect to the axis of rotation of the pedal crankshaft, so that the planetary gear coaxially surrounds the pedal crankshaft. Thus, the planetary gear can be arranged radially and in a space-saving manner.

According to a further embodiment of the drive device, the motor unit is designed as a ring motor and is arranged coaxially around the pedal crankshaft with respect to the axis of rotation of the pedal crankshaft, so that the ring motor coaxially surrounds the pedal crankshaft. Thus, the ring motor can be arranged radially and in a space-saving manner.

According to a further embodiment of the drive device, the pedal crankshaft is of two-part design and has a first part element and a separate second part element which are coupled to one another. In particular, due to the two-part design of the pedal crankshaft, the pedal crankshaft can be made significantly thinner or narrower in a middle section than at one or both outer end sections. In particular, the pedal crankshaft is rotationally symmetrical and has, for example, a diameter of inclusive 15-23 mm in the middle section and a diameter of inclusive 23-35 mm in the end section.

In addition, the pedal crankshaft can also be formed in three parts, four parts or multiple parts. The first part element and the second part element each have two end portions, one of which also forms an end portion and the other of which forms a middle portion of the pedal crankshaft. With the respective end portion of the part elements forming the central portion of the pedal crankshaft when assembled, the part elements are coupled to each other, for example plugged together, pressed together, welded and/or screwed together. Thus, the middle section of the assembled pedal crankshaft is formed, which may be designed to be significantly narrower than the two end sections intended to be connected to pedal cranks of an electric bicycle.

The pedal crankshaft may further form a bearing seat for the planetary gear and/or the ring motor. In this way, one or both components can be arranged radially and in a particularly space-saving manner by coupling them to the pedal crankshaft using, for example, ball and/or roller bearings.

With respect to embodiments of the gearbox as a planetary gear and the motor unit as a ring motor, these components may be slipped or pushed onto the narrower end portion of one or both of the part elements before the part elements are coupled together. Accordingly, a method of manufacturing the drive device may include providing and coupling the respective components. For example, the motor unit is slid onto a narrower end portion of the first part element as a ring motor and thereupon the planetary gear is also arranged radially therearound. Subsequently, an end portion of the second part element can be fixedly connected to the narrower end portion of the first part element.

According to a further preferred embodiment of the drive device, the first part element and/or the second part element are sleeve-shaped at least in a coupling region, so that at least one of the two part elements extends into the other. In this case, the coupling region forms the region of the end sections of the part elements to be connected, which form a central section of the pedal crankshaft and, in particular, can be designed to be narrower than the other end sections. The part element or elements may be of continuous or only sectional sleeve design.

According to a further preferred embodiment of the drive device, the first and second part elements are coupled to one another by means of a predetermined coupling structure which connects the two part elements to one another in a form-fitting, force-fitting and/or material-fitting manner. Such a coupling structure may also comprise a screw element that extends along the axis of rotation into the two part elements and screws them together. Alternatively or additionally, the coupling structure may be formed such that one part element has a protruding or raised region which is predefined in coordination with a corresponding recess on the other part element. For example, one or more pins are formed on an outer surface of the first part element, which engage in correspondingly designed recesses on an inner surface of the sleeve-shaped second part element. Thus, a reliable hold of the two part elements with each other can be realized, which can provide a certain positional specification of the two part elements, which can additionally be screwed, glued and/or welded.

As a result of the fact that at least the speed disc is arranged outside the motor housing, the motor housing can be made smaller and, for example, the motor unit and the gearbox, in particular in the form of a ring motor and planetary gear, can be placed in the motor housing around the narrow central section of the pedal crankshaft in a particularly space-saving manner. The end sections of the pedal crankshaft then extend, for example, to the outside of the motor housing and can in particular also be formed as a bearing seat for the motor housing and have edge projections or steps which define a predetermined position of the motor housing relative to the pedal crankshaft and can also contribute to a stable and secure hold.

The drive device may further include a torque sensor disposed outside of the motor housing with respect to the axis of rotation. Further, a chainring system may be provided that is coupled to the pedal crankshaft for driving the electric bicycle, wherein the torque sensor is integrated into the chainring system. The torque sensor outside the motor housing integrated in the spider further enables a compact housing installation space and thus a particularly slim frame design, as well as beneficial serviceability of the torque sensor due to its easier accessibility. The chainring system has a plurality of chainrings or gear-shaped elements coupled together and can also be referred to by the English term “spider”. The torque sensor then monitors in particular a relative movement of interlocking structures of the chainring system and enables safe operation of the electric bicycle with improved riding comfort.

The described embodiments of the drive device each enable a compact, lightweight and/or inexpensive-to-manufacture electric drive system for an electric bicycle. In particular, in the embodiment with a ring motor and a planetary gear, which are arranged coaxially around a narrow center of the pedal crankshaft, which can also act as a bearing seat, a particularly space-saving and robust design of the drive device is possible through functional integration. Furthermore, the speed sensor is provided with the speed disc, which is formed as a helix or spiral or as a multi-tooth gear and is arranged outside the housing installation space of the motor housing, so that a slim frame design of the electric bicycle can be further contributed to.

According to a further embodiment, there is disclosed an electric bicycle comprising a bicycle frame having a lower frame portion extending to a bottom bracket having a pedal crank. The electric bicycle includes a drive device according to any of the previously described embodiments disposed in or on the frame portion, such that the pedal crankshaft is coupled to the pedal crank and torque is transmittable by means of the gearbox to drive the electric bicycle. The electric bicycle substantially enables the aforementioned features, advantages, and functions.

For example, for attachment to the frame portion, the frame portion has a recess so that the drive device can be reliably received. According to one embodiment, the drive device is arranged, for example as an assembly in the already coupled state on the frame section, in particular mounted.

The drive device enables an efficient and space-saving mechanical system for assisting in cycling. This is made possible in particular by the two-part or multi-part design of the pedal crankshaft, which can thereby be formed in an inner or middle section with a significantly smaller outer diameter than at the end sections located on the outside.

### BRIEF DESCRIPTION OF THE DRAWINGS

Embodiments, advantages and functions are explained in the following description by means of embodiment examples with the aid of the attached figures.

FIG. 1 shows a schematic view of an electric bicycle with a drive device mounted;

FIG. 2 shows a schematic sectional view of an embodiment of the drive device for the electric bicycle;

FIG. 3 shows a further schematic sectional view of components of the drive device according to FIG. 2; and

FIGS. 4-5 show schematic embodiments of a speed sensor unit of the drive device according to FIG. 2.

### DETAILED DESCRIPTION OF ILLUSTRATIVE EMBODIMENTS

Identical, similar or similarly acting elements are given the same reference signs in the figures. For reasons of clarity, not all the elements shown in all the figures are marked with the corresponding reference signs, possibly.

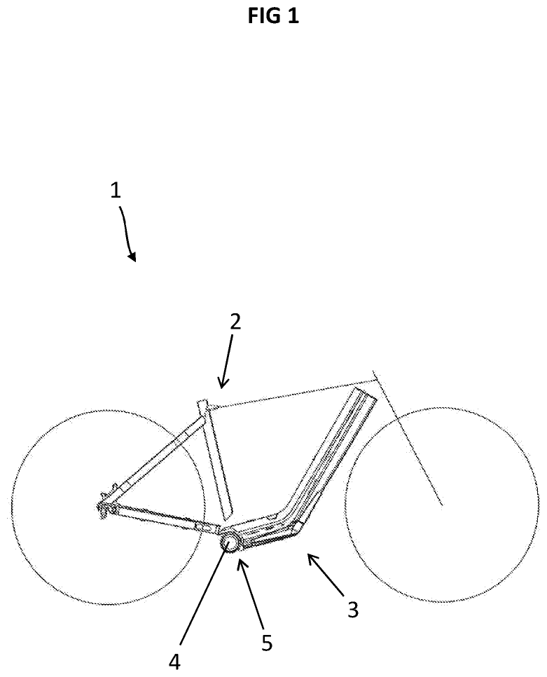

FIG. 1 schematically shows an electric bicycle 1 with a bicycle frame 2, which has, among other things, a lower frame section 3, which forms a down tube. The frame section 3 extends in the direction of a bottom bracket, which comprises a pedal crank 4 that is coupled or can be coupled to an electric drive device 5 for the electric bicycle 1.

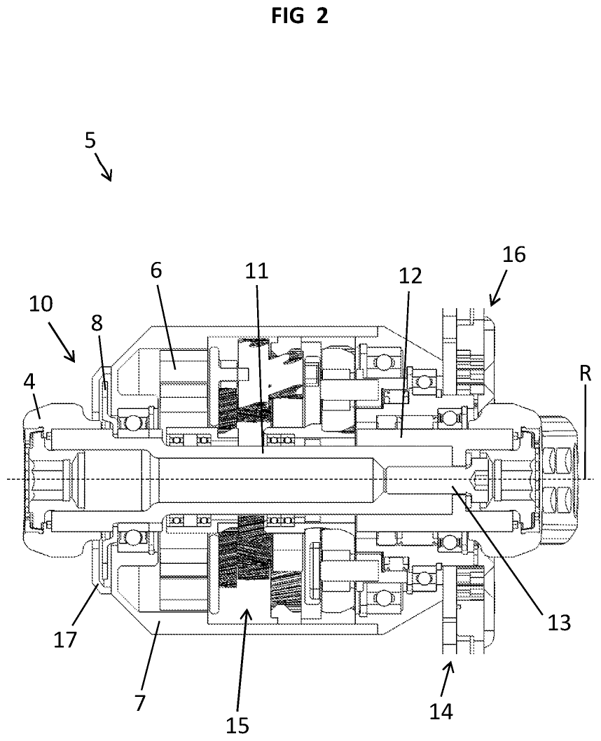

FIGS. 2-5 schematically show an embodiment example of the drive device 5 or of components of the drive device 5. FIG. 2 shows a sectional view through the drive device 5, which comprises, among other things, a motor unit with an electric motor, which is designed as a ring motor 6 for driving the electric bicycle 1. The drive device 5 further comprises a pedal crankshaft, which is rotatable about an axis of rotation R and which is formed in two parts and comprises a first part element 11 and a second part element 12, which are coupled to each other.

The drive device 5 further comprises a gearbox configured as a planetary gear 15 having a sun gear and at least one planetary gear for driving the electric bicycle 1. The planetary gear 15 is coupled on the one hand to the ring motor 6 and on the other hand to the pedal crankshaft 11, 12 and is arranged to output a torque for driving the electric bicycle 1.

The planetary gear 15 and the ring motor 6 are each arranged coaxially about the pedal crankshaft 11, 12 with respect to the axis of rotation R of the pedal crankshaft 11, 12 so that they coaxially surround the pedal crankshaft 11, 12. The pedal crankshaft 11, 12 thereby forms a bearing seat for the planetary gear 15 and the ring motor 6. In particular, the fact that the pedal crankshaft 11, 12 is narrower in a central section than at its end sections makes it possible to achieve a particularly space-saving and clear structure of the drive device 5.

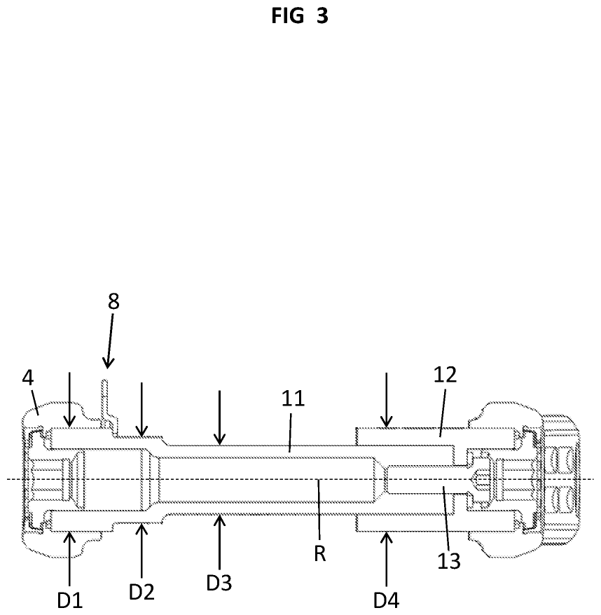

FIG. 3 shows a clearer illustration of a possible design of the two-part pedal crankshaft 11, 12 according to FIG. 2. The two part elements 11 and 12 each have two end sections, one of which faces the respective other part element 11, 12 and the other of which in each case forms an outer end section of the assembled pedal crankshaft. The two outer end portions are connected to the pedal cranks 4 of the electric bicycle 1.

The first part element 11 has a significantly narrower configuration in the portion which is coupled to the second part element 12 than in its opposite end portion. For example, at the outer end portion, the first part element 11 has a first diameter D1 that is larger than a second diameter D2 of an inwardly oriented adjacent region. A further section of the first part element 11 adjoins this area, which has a third diameter D3 that is smaller than the second diameter D2. The various diameters D1-D3 are formed in a predetermined manner, in particular with regard to the arrangements of the interacting components of the drive device 5. The first part element 11 is formed in the shape of a sleeve, so that the diameters D1-D3 described refer to a respective outer diameter of such a shaft sleeve.

The second part element 12 is also of sleeve-shaped design and has a predetermined outer diameter D4, which may be referred to as the fourth diameter of the pedal crankshaft and which corresponds, for example, in value to the first diameter D1. In the section which is coupled to the first part element 11, the second part element 12 preferably has an inner diameter which essentially corresponds to the third diameter D3 of the first part element 11 and is only slightly smaller. Thus, the first part element 11 can extend into the second part element 12 and be interlocked, pressed and/or welded thereto.

The pedal crankshaft has, for example, in the middle portion, the second and third diameters D2 and D3 of the first part element 11, which have, for example, a value between 15-23 mm inclusive. In the outer end sections, which correspond on the one hand to the area of the first part element 11 with the first diameter D1 and on the other hand to the area of the second part element 12 with the fourth diameter D4, the pedal crankshaft has, for example, an extension of 23-35 mm inclusive in each case.

The two part elements 11 and 12 are coupled to one another by means of a screw element 13 which extends along the axis of rotation R through the second part element 12 into the first part element 11 and screws the two part elements 11, 12 to one another. In this respect, the first part element 11 has a threaded section on an inner side which interacts with the screw element 13. According to such an embodiment, the second part element 12 is preferably formed as a shaft sleeve with a transverse wall which has a through opening in coordination with the screw element 13. According to the embodiment example illustrated in FIGS. 2 and 3 in sectional view, such a shaft sleeve corresponds to a letter “H” lying on its side.

Alternatively or additionally, the first and second part elements 11, 12 may be coupled to each other by means of a further coupling structure which couples the two part elements 11, 12 to each other in a form-fitting, force-fitting and/or material-fitting manner.

Furthermore, the drive device 5 has a speed sensor unit 10 and a torque sensor 14, each of which is arranged outside a motor housing 7. The ring motor 6 and the planetary gear 15 are arranged in the motor housing 7. The pedal crankshaft 11, 12 extends through the motor housing 7. The motor housing 7 serves to protect the ring motor 6, the planetary gear 15 and other elements interacting therewith, such as ball or roller bearings. In addition, the motor housing 7 enables reliable connection of the drive device 5 to the bicycle frame 2 or the frame section 3.

The speed sensor unit 10 comprises a speed sensor 9 and a speed disc 8, the latter being coupled to the pedal crankshaft 11, 12 so as to be rotatable about the axis of rotation R (see FIG. 2). The speed disc 8 is arranged outside the motor housing 7 between the pedal crank 4 and the motor housing 7 with respect to the axis of rotation R. The speed disc 8 is connected to the pedal crank shaft 11, 12. The speed disc 8 is connected to the pedal crankshaft 11, 12 at a predetermined position at the end portion where the first part element 11 changes its dimension from D1 to D2. Such a transition may be oblique, angular or curved, and may in particular be adapted to a tethering of the speed disc 8. The drive device 5 also has a cover 17 which covers the speed disc 8 and protects it from external influences. The cover 17 is coupled to the motor housing 7, so that the speed disc 8 is arranged between the cover 17 and the motor housing 7.

The torque sensor 14 is integrated into a chainring system 16 coupled to the pedal crankshaft 11, 12 for driving the electric bicycle 1 and having a plurality of chainrings or gear-shaped elements that initiate manual operation of the electric bicycle 1 and engagement of the electric drive device 5 to assist the rider of the electric bicycle 1 as needed.

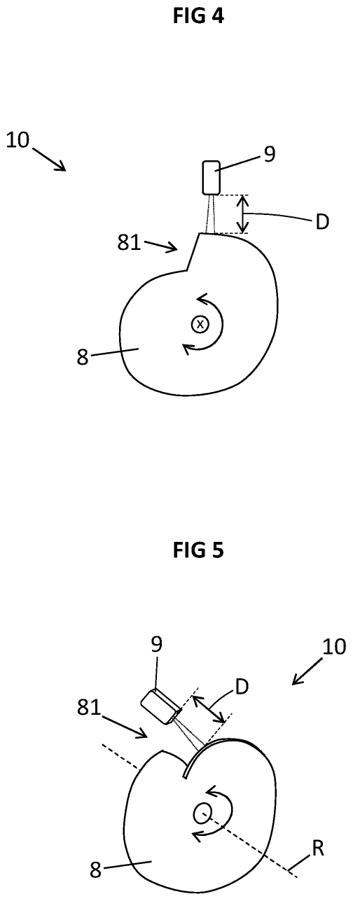

FIGS. 4 and 5 show embodiments of the rotational disc 8, which can have a spiral contour (see FIG. 4) or a helical contour (see FIG. 5) with respect to the rotational axis R. The rotational speed sensor 9 is arranged in such a way that, depending on the contour of the rotational disc 8, radial speed detection is possible (see FIG. 4). The speed sensor 9, which is implemented for example as a Hall sensor, is arranged depending on the contour of the speed disc 8 in such a way that radial speed detection (see FIG. 4) or axial speed detection (see FIG. 5) is set up with respect to the axis of rotation R. The speed sensor 9 is arranged in such a way that radial speed detection (see FIG. 4) or axial speed detection (see FIG. 5) is set up with respect to the axis of rotation R.

Radial speed detection is illustrated schematically in FIG. 4 and is performed by measuring the distance of the rotating speed disc 8 in a direction transverse to the axis of rotation R, in particular perpendicular to it. The speed disc 8 has an edge or a step contour 81 on its circumference which can be reliably detected by means of the speed sensor 9. A distance D between the speed sensor 9 and the contour of the speed disc 8 undergoes a step change in the area of the step contour 81. In addition, the distance D also changes continuously due to the spirally rotating contour of the speed disc 8. The distance D to be measured is therefore variable.

The same applies analogously to the axial speed measurement according to FIG. 5, according to which the distance measurement of the rotating speed disc 8 is carried out in the axial direction, for example parallel to the axis of rotation R. The speed disc 8 is helically rotated. The speed disc 8 is helical or screw-like in shape, so that the distance D between the speed sensor 9 and a surface of the speed disc 8 facing the speed sensor 9 changes. In particular, such a change occurs continuously until a step change is detected in the step contour 81 area. The distance D to be measured is thus also variable according to such an orientation of the speed sensor unit 10. In particular with such an axial speed detection, the speed sensor 9 can, for example, be arranged in an existing free space in the motor housing 7 and detect a rotation of the externally mounted speed disc 8. In FIG. 2, an arrangement of the speed sensor 9 is possible, for example, in the area between the ring motor 6 and the speed disc 8. The motor housing 7 can then have an opening in the direction of the speed disc 8, for example, which enables reliable speed measurement.

By means of the described drive device 5, a reliable drive concept for electric bicycles can be realized, which enables a particularly and space-saving structure. The drive device 5 is particularly suitable for mounting on a down tube or on a seat tube of the electric bicycle 1 and enables an advantageous drive system, particularly with regard to a high efficiency and a small size.

The invention claimed is:

1-12. (canceled)

13. A drive device comprising:
a motor unit having an electric motor configured to drive an electric bicycle;
a pedal crankshaft rotatable about an axis of rotation;
a gearbox coupled to the motor unit and to the pedal crankshaft, the gearbox configured to output a torque for driving the electric bicycle;
a motor housing in which the motor unit and the gearbox are arranged and through which the pedal crankshaft extends; and
a speed sensor unit comprising a speed sensor and a speed disc,
wherein the speed disc is coupled to the pedal crankshaft so as to be rotatable about the axis of rotation, and is arranged outside the motor housing.

14. The drive device according to claim 13,
wherein the speed disc has a spiral or helical contour with respect to the axis of rotation, and
wherein the speed sensor is arranged depending on the contour of the speed disc in such that a radial or axial speed detection is set up with respect to the axis of rotation.

15. The drive device according to claim 13, further comprising a cover covering the speed disc and coupled to the motor housing so that the speed disc is arranged between the cover and the motor housing.

16. The drive device according to claim 13, wherein the gearbox is a planetary gear with a sun gear and at least one planet gear and is arranged coaxially around the pedal crankshaft with respect to the axis of rotation thereof so that the planetary gear coaxially surrounds the pedal crankshaft.

17. The drive device according to claim 13, wherein the motor unit is a ring motor and is arranged coaxially around the pedal crankshaft with respect to the axis of rotation so that the ring motor coaxially surrounds the pedal crankshaft.

18. The drive device according to claim 13, wherein the pedal crankshaft is a two part element comprising a first part element and a second part element, which are coupled to each other.

19. The drive device according to claim 18, wherein the first part element and the second part element are coupled to one another by a coupling structure which couples the two part element to one another in a form-fitting, force-fitting and/or material-fitting manner.

20. The drive device according to claim 18, wherein the first part element and/or the second part element are formed in a sleeve shape at least in a coupling region and at least one part element of the two part element extends into the other.

21. The drive device according to claim 13, wherein the pedal crankshaft is narrower in a middle section than in an end section with respect to the axis of rotation.

22. The drive device according to claim 13, further comprising a torque sensor arranged outside the motor housing with respect to the axis of rotation.

23. The drive device according to claim 22, further comprising a chainring system coupled to the pedal crankshaft, the chainring system configured to drive the electric bicycle, wherein the torque sensor is integrated in the chainring system.

24. The electric bicycle comprising:
a bicycle frame with a lower frame portion extending to a bottom bracket bearing comprising a pedal crank; and
the drive device according to claim 13 coupled to the bicycle frame such that the pedal crankshaft is coupled to the pedal crank.
